(19) United States
(12) Patent Application Publication
(10) Pub. No.: US 2025/0024476 A1
(43) Pub. Date: Jan. 16, 2025

(54) METHOD AND APPRATUS FOR RELAY NODE CONFIGURATION AND PROTOCOL STACKS

(71) Applicant: MEDIATEK INC., Hsinchu City (TW)

(72) Inventors: Guan-Yu LIN, Hsinchu City (TW); Chia-Hao YU, Hsinchu City (TW); Lung-Sheng TSAI, Hsinchu City (TW); Nathan Edward TENNY, San Jose, CA (US)

(21) Appl. No.: 18/711,013

(22) PCT Filed: Jan. 10, 2023
(86) PCT No.: PCT/CN2023/071612

§ 371 Date: May 16, 2024

Related U.S. Application Data
(60) Provisional application No. 63/297,852, filed on Jan. 10, 2022.

(51) Int. Cl. H04W 72/51; H04W 72/0453

(52) U.S. Cl. CPC H04W 72/51; H04W 72/0453

(57) ABSTRACT

A synergetic communication method for relay node configuration and protocol stacks is proposed. A network node may generate a scheduling which indicates the relay node configurations associated with an aggregated group based on the capability information from a user equipment (UE). The scheduling may comprise different configurations for the relay nodes in the aggregated group. In addition, the network node may transmit or schedule the scheduling for controlling the aggregated group to the UE. The UE may transmit the capability information associated with the relay node(s) in the aggregated group to the network node. Therefore, the network node is able to configure the configuration for the relay node with limited capability.

### CROSS REFERENCE TO RELATED APPLICATIONS

This application claims priority under 35 U.S.C. § 119 from U.S. Provisional Application No. 63/297,852, entitled “On Configuration and Protocol Stacks to support Synergetic UE Communication”, filed on Jan. 10, 2022, the subject matter of which is incorporated herein by reference.

### TECHNICAL FIELD

The disclosed embodiments relate generally to wireless communication, and, more particularly, to relay node configuration and protocol stack in relay communications.

### BACKGROUND

The wireless communications network has grown exponentially over the years. A long-term evolution (LTE) system offers high peak data rates, low latency, improved system capacity, and low operating cost resulting from simplified network architecture. LTE systems, also known as the 4G system, also provide seamless integration to older wireless network, such as GSM, CDMA and universal mobile telecommunication system (UMTS). In LTE systems, an evolved universal terrestrial radio access network (E-UTRAN) includes a plurality of evolved Node-Bs (eNodeBs or eNBs) communicating with a plurality of mobile stations, referred to as user equipments (UEs). The 3rd generation partner project (3GPP) network normally includes a hybrid of 2G/3G/4G systems. The next generation mobile network (NGMN) board, has decided to focus the future NGMN activities on defining the requirements for 5G new radio (NR) systems or 6G systems.

In conventional 5G technology, the relay communication via a relay node has the potential to modernize mobile communications for vehicles or other application scenarios. However, when the relay node is not able to directly communicates with the network node due to the limited capability information of the relay node, e.g., the relay node is a layer 0 (L0) relay node or a layer 1 (L1) relay node, the network node is not able to obtain the capability of the relay node. Therefore, the network node is not able to configure the configuration for the relay node with limited capability. In addition, the protocol stacks for the relay communication have not been defined yet.

A solution for relay node configuration and protocol stacks is sought.

### SUMMARY

A synergetic communication method for relay node configuration and protocol stacks is proposed. A network node may generate a scheduling which indicates the relay node configurations associated with an aggregated group based on the capability information from a user equipment (UE). The scheduling may comprise different configurations for the relay nodes in the aggregated group. In addition, the network node may transmit or schedule the scheduling for controlling the aggregated group to the UE. The UE may transmit the capability information associated with the relay node(s) in the aggregated group to the network node. Therefore, in the present application, the network node is able to configure the configuration for the relay node with limited capability.

In one embodiment, a network node receives capability information of an aggregated group formed by a user equipment (UE) and at least one relay node from the UE. Then, the network node generates a scheduling based on the capability information. In addition, the network node transmits the scheduling for controlling the aggregated group to the UE. The scheduling comprises different configurations for the at least one relay node in the aggregated group.

In one embodiment, a user equipment (UE) determines at least one path from paths between a network node and an aggregated group formed by the UE and at least one relay node. In addition, the UE transmits a traffic to the network node through the determined at least one path in a Packet Data Convergence Protocol (PDCP) layer or in a Radio Frequency (RF) layer.

Other embodiments and advantages are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 illustrates an exemplary synergetic communication network in accordance with aspects of the current invention.

FIG. 2A is a schematic diagram of an aggregated group in accordance with one novel aspect.

FIG. 2B is a schematic diagram of an aggregated group in accordance with another novel aspect.

FIG. 2C is a schematic diagram of an aggregated group in accordance with another novel aspect.

FIG. 3 is a simplified block diagram of a network node and a user equipment that carry out certain embodiments of the present invention.

FIG. 4A illustrates a protocol stack for L2 relay node in accordance with one novel aspect.

FIG. 4B illustrates a protocol stack for L2 relay node in accordance with another novel aspect.

FIG. 5A illustrates a protocol stack for L1 relay node in accordance with one novel aspect.

FIG. 5B illustrates a protocol stack for L1 relay node in accordance with another novel aspect.

FIG. 6 illustrates a relay node configuration process in accordance with one novel aspect.

FIG. 7 is a flow chart of a method for configuring relay node configuration in accordance with one novel aspect.

FIG. 8 is a flow chart of a method for applying protocol stack in accordance with one novel aspect.

### DETAILED DESCRIPTION

Reference will now be made in detail to some embodiments of the invention, examples of which are illustrated in the accompanying drawings.

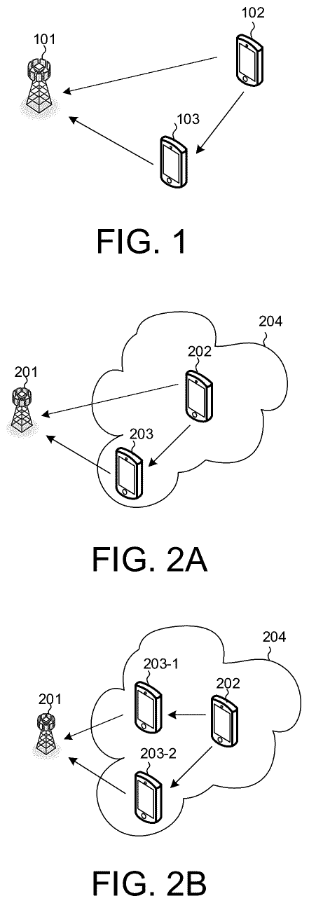

FIG. 1 illustrates an exemplary synergetic communication network in accordance with aspects of the current invention. The synergetic communication network comprises a network node 101, a user equipment (UE) 102 and at least one relay node 103. It should be noted that FIG. 1 only shows one relay node 103, but the invention should not be limited thereto. The synergetic communication network may comprise more than one relay node. The synergetic communication network may be applied to Sidelink (SL) communication or other relay communications.

The network node 101 may be communicatively connected to a user equipment (UE) 102 operating in a licensed band (e.g., 30 GHz˜300 GHz for mmWave) of an access network which provides radio access using a Radio Access Technology (RAT) (e.g., the 5G NR technology). The access network may be connected to a 5G core network by means of the NG interface, more specifically to a User Plane Function (UPF) by means of the NG user-plane part (NG-u), and to a Mobility Management Function (AMF) by means of the NG control-plane part (NG-c). One gNB can be connected to multiple UPFs/AMFs for the purpose of load sharing and redundancy.

The network node 101 may be a base station (BS) or a gNB.

The UE 102 may be a smart phone, a wearable device, an Internet of Things (IOT) device, and a tablet, etc. Alternatively, UE 102 may be a Notebook (NB) or Personal Computer (PC) inserted or installed with a data card which includes a modem and RF transceiver(s) to provide the functionality of wireless communication.

The relay node 103 may be a layer 2 (L2) relay node, a layer 1 (L1) relay node or a layer 0 (L0) relay node.

L2 relay node may have capability of decoding the received packets to the level of L2 packets (i.e., in the unit of Medium-Access-Control Protocol-Data-Unit (MAC PDU), MAC Service Data Unit (SDU), RLC SDU, Radio Link Control (RLC) PDU, Packet Data Convergence Protocol (PDCP) SDU, or PDCP PDU), assembling the received L2 packets to form a new MAC PDU and forwarding the new MAC PDU to the next hop. That is to say, the L2 relay node may have similar functionalities as the UE 102. In L2 relay, a L2 relay node connects to the network before it transmits discovery message to announce itself as a L2 relay UE. During network connection establishment, a L2 relay node directly obtains the relay node identification (ID) from the network node 101 (same as legacy UE). That is, L2 relay node has capability to acquire its distinct network-recognizable ID (i.e., Cell-Radio Network Temporary Identifier (C-RNTI)) from the network directly.

L1 relay node may have functionalities between L0 relay node and L2 relay node. In an example, L1 relay node does not do L2 decoding for received control signaling and data which is to be forwarded to the network or other UE but is not for itself. In another example, the L1 relay node may support L2 decoding for its own control signaling, i.e. L1 relay node may be configured by L1 (e.g., Channel State Information (CSI) and/or Downlink Control Information, DCI) or L2 signaling (MAC Control Element (CE) or Radio Resource Control (RRC) configuration). L1 relay node may perform L1 procedure such as beam management, power control, or time slot specific on-off operation, which may follow the instruction of the received control signaling from the network. L1 relay node may not directly obtain the relay node identification (ID) from the network node 101, i.e., a L1 relay node may not have a UE ID (e.g., C-RNTI for network recognition) assigned by the network.

L0 relay node may only have the capability of amplifying and forwarding the received signal. L0 relay node may not directly obtain the relay node identification (ID) from the network node 101 (e.g., C-RNTI).

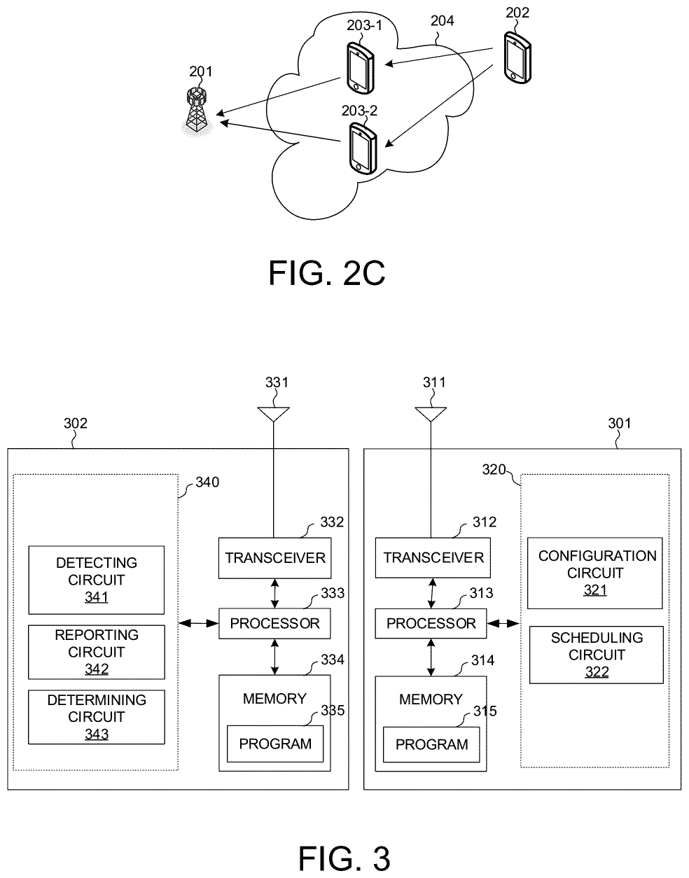

In accordance with one novel aspect, the UE 102 and the relay node(s) 103 may form an aggregated group. The UE 102 may coordinate the operations in the aggregated group. Taking FIG. 2A and FIG. 2B as examples. As shown in FIG. 2A, UE 202 and relay node 203 may form an aggregated group 204. As shown in FIG. 2B, UE 202, relay node 203-1 and relay node 203-2 may form an aggregated group 204. The type of aggregated group may be based on the type of the relay node(s) (e.g., the relay node is L2 relay node, L1 relay node or L0 relay node) in the aggregated group.

In accordance with another novel aspect, the relay nodes 103 may form an aggregated group, i.e., the aggregated group does not comprise the UE 102. In the aggregated group, a relay node 103 may be regarded as a master relay node (or relay node lead) which has better capability than other relay nodes 103 of the aggregated group, e.g., the master relay node is a L2 relay node and other relay nodes of the aggregated group are L1 relay nodes or L0 relay node. Taking FIG. 2C as an example. As shown in FIG. 2C, the aggregated group 204 may comprise the relay node 203-1 and relay node 203-2 and the relay node 203-1 is the master relay node. The master relay node may coordinate the operations in the aggregated group.

In accordance with a novel aspect, the network 101 may receive capability information of an aggregated group formed by the UE 102 and at least one relay node 103 from the UE 102. Then, the network 101 may generate a scheduling based on the capability information. In addition, the network node 101 may transmit the scheduling for controlling the aggregated group to the UE 102. The scheduling for controlling the aggregated group may comprise different configurations (or relay-specific configurations) for the at least one relay node 103 in the aggregated group. That is, different relay nodes 103 in the same aggregated group may have different configurations.

In accordance with a novel aspect, the scheduling for controlling the aggregated group may comprise at least one of downlink control information (DCI), a medium-access-control control clement (MAC CE) and a radio resource control (RRC) message. In an example, the network node 101 may transmit the scheduling (i.e., DCI, MAC CE or RRC message) to the UE 102 to indicate which relay node 103 (or relay nodes 103) in the aggregated group are configured for the uplink (UL) transmission or downlink transmission. Furthermore, the DCI, MAC CE or RRC message may further indicate whether the UE 102 is configured for the UL transmission or DL transmission with the configured relay node 103 (or relay nodes 103) in the aggregated group. In addition, the relay nodes 103 configured (selected) for UL transmission or DL transmission may have different configurations. The network node 101 may modify the DCI, MAC CE or RRC message to indicate the configurations for controlling the aggregated group.

In accordance with a novel aspect, the configuration for the relay node 103 may comprise at least one of a power configuration, a frequency resource configuration (e.g., band, component carrier (CC) or frequency resource used for frequency translation), a measurement configuration (e.g., the resource configured for measurement), an uplink (UL) grant, a downlink (DL) assignment and a physical uplink control channel (PUCCH) resource (e.g., Hybrid Automatic Repeat reQuest (HARQ), ACK, NACK and periodic channel state information (CSI) report).

In accordance with a novel aspect, the UE 102 may determine at least one path from paths between the network node 101 and an aggregated group formed by the UE 102 and at least one relay node 103. Then, the UE 102 may transmit a traffic to the network node 101 through the determined at least one path in a Packet Data Convergence Protocol (PDCP) layer or in a Radio Frequency (RF) layer.

In accordance with a novel aspect, when the at least one relay node 103 is the layer 2 (L2) relay node, the UE 102 may transmit the traffic to the network node 101 through the determined at least one path in the PDCP layer.

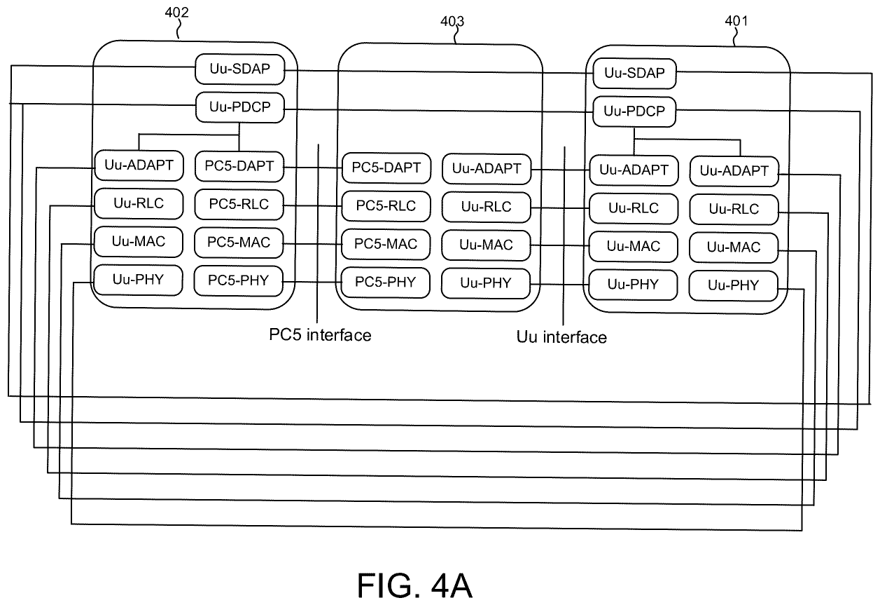

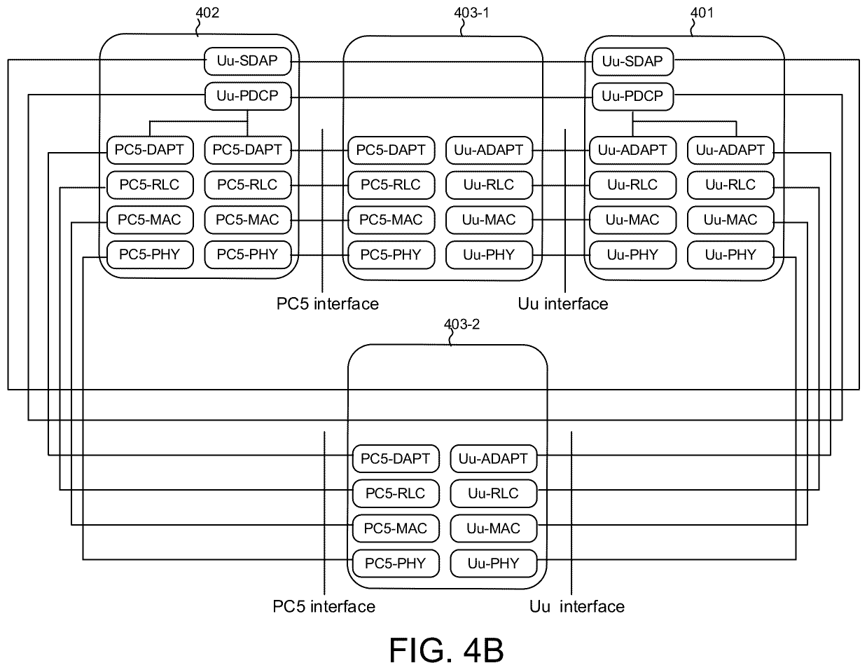

In an embodiment, the UE 102 may transmit the traffic to at least one relay node 103 (i.e., the relay node 103 is L2 relay node) of the aggregated group through a PC5 interface. That is, in the path of the embodiment, the UE 102 needs to transmit the traffic to the relay node 103 first, and then the relay node 103 may transmit the traffic to the network node 101. Taking FIG. 4A as an example, if the aggregate group comprise the UE 402 and the relay node 403 (L2 relay node), the UE 402 may transmit the traffic to the relay node 403 through the PC5 interface (e.g., PC5 RLC Channel). Then, the relay node 403 may transmit the traffic to the network node 401 through the Uu interface (e.g., Uu RLC Channel). Taking FIG. 4B as another example, if the 35 aggregate group comprise the UE 402, the relay node 403-1 (L2 relay node) and the relay node 403-2 (L2 relay node), the UE 402 may transmit the traffic to the relay node 403-1 and the relay node 403-2 through the PC5 interface. Then, the relay node 403-1 and the relay node 403-2 may transmit the traffic to the network node 401 through the Uu interface.

In another embodiment, the UE 102 may transmit the traffic to the network node 101 directly through an Uu interface in an adaption (ADAPT) layer. That is, in the path of the embodiment, the UE 102 is able to transmit the traffic to the network node 101 directly. Taking FIG. 4A as an example, if the aggregate group comprise the UE 402 and the relay node 403, the UE 402 may transmit the traffic to the network node 101 directly through the Uu interface in the adaption (ADAPT) layer.

It should be noted that in FIG. 4A, the UE 402 may transmit the traffic to the relay node 403 through the PC5 interface and transmit the traffic to the network node 401 directly through the Uu interface. That is, in FIG. 4A, the UE 402 may transmit the traffic through these two paths at the same time.

In another embodiment, if the UE 102 and network 103 are not configured adaption (ADAPT) layers, the UE 102 may transmit the traffic to the network node 101 directly through the Uu interface in a Radio Link Control (RLC) layer. Taking FIG. 4A as an example, if the UE 402 and network 403 are not configured Uu-adaption (ADAPT) layers, the Un-PDCP layer of the UE 402 may be connected to the Un-RLC layer of the UE 402, and the Un-PDCP layer of the network node 401 may be connected to the Un-RLC layer of the network node 401. Therefore, the UE 402 may transmit the traffic to the network node 101 directly through the Uu interface in the RLC layer.

In accordance with another novel aspect, when the at least one relay node 103 is the layer 1 (L1) relay node, the UE 102 may transmit the traffic to the network node 101 through the determined at least one path in the RF layer.

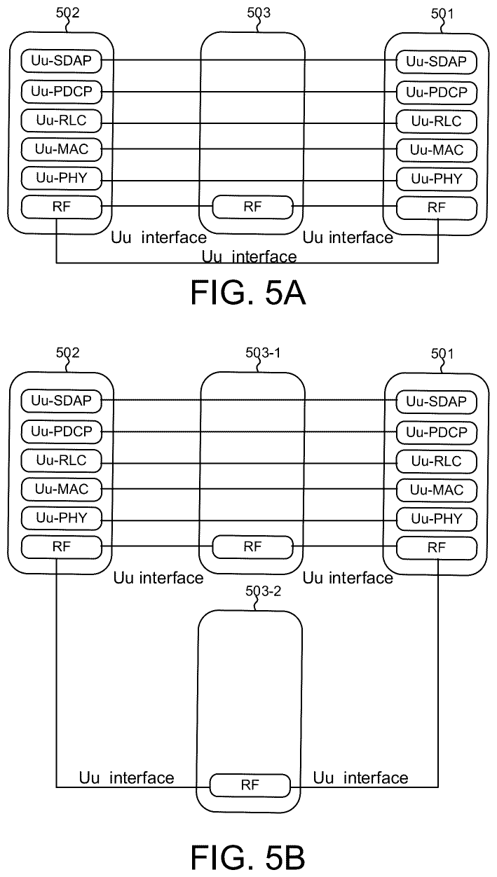

In an embodiment, the UE 102 may transmit the traffic to at least one relay node 103 (i.e., the relay node 103 is L1 relay node) of the aggregated group through an Uu interface. Then, the relay node 103 may transmit the traffic to the network node 101 through the Uu interface. That is, in the path of the embodiment, the UE 102 needs to transmit the traffic to the relay node 103 first, and then the relay node 103 may transmit the traffic to the network. Taking FIG. 5A as an example, if the aggregate group comprise the UE 502 and the relay node 503 (L1 relay node), the UE 502 may transmit the traffic to the relay node 503 through the Uu interface in the RF layer. Then, the relay node 503 may transmit the traffic to the network node 501 through the Uu interface in the RF layer. Taking FIG. 5B as another example, if the aggregate group comprise the UE 502, the relay node 503-1 (L1 relay node) and the relay node 503-2 (L1 relay node), the UE 502 may transmit the traffic to the relay node 503-1 and the relay node 503-2 through the Uu interface in the RF layer. Then, the relay node 503-1 and the relay node 503-2 may transmit the traffic to the network node 501 through the Uu interface in the RF layer.

In another embodiment, the UE 102 may transmit the traffic to the network node 101 directly through the Uu interface in the RF layer. That is, in the path of the embodiment, the UE 102 is able to transmit the traffic to the network node 101 directly. Taking FIG. 5A as an example, if the aggregate group comprise the UE 502 and the relay node 503, the UE 502 may transmit the traffic to the network node 101 directly through the Uu interface in the RF layer.

It should be noted that in FIG. 5A, the UE 502 may transmit the traffic to the relay node 503 through the Uu interface and transmit the traffic to the network node 501 directly through the Uu interface. That is, in FIG. 5A, the UE 502 may transmit the traffic through these two paths at the same time.

In accordance with another novel aspect, when the at least one relay node 103 is the layer 1 (L1) relay node, the L1 relay node may be embedded additional functions, e.g., power control, beam direction, etc. Therefore, the UE 102 may transmit the traffic to the network node 101 through the determined at least one path in the Physical (PHY) layer. Taking FIG. 5A as an example, if the relay node 503 is embedded additional functions, the UE 502 may also be able to transmit the traffic to the relay node 503 through the Uu interface in the PHY layer. Then, the relay node 503 also be able to transmit the traffic to the network node 501 through the Uu interface in the PHY layer.

In accordance with another novel aspect, the protocol stack (as in FIG. 5A and FIG. 5A) could be only for communication between the UE 502 and the network node 501. That is, the communication between relay UE 503 and the network node 501, and/or the communication between the UE 502 and the relay node 503 may follow a different protocol stack. For example, there may be full L1/L2 protocol stacks (including PHY/MAC/RLC/PDCP/SDAP) for communication between the UE 502 and the relay node 503, so that the relay node 503 and the UE 502 can exchange (e.g., decode and apply) control signaling via direct UE-to-UE interface (e.g., PC5 interface using separate sidelink resource or non-3GPP interface using unlicensed spectrum). Similarly, there may be full L1/L2 protocol stacks for communication between the relay node 503 and the network node 501, if the relay node 530 which supports RF relay also has L1/L2 capability. In other words, a relay node 503 may apply different protocol stacks to handle traffic from/to itself (e.g., by full L1/L2 function) and traffic to be forwarded from/to the UE 502 (e.g., by RF function).

In accordance with another novel aspect, for a relay node capable of multiple relay modes (RF/L1/L2 relay), for downlink (DL) traffic, the network node could indicate which relay mode the relay node should apply to forward the DL data. For one example, the network node may use DCI to indicates the relay mode, and the relay node can accordingly determine whether to decode it before forwarding. For one example, some DL resource (e.g., in at least one of time, frequency, power, and coding domain) is associated with a specific relay mode. If a relay node receives DL data within a DL resource pool dedicated for L2 relay, relay node knows that the DL data should be decoded and reassembled before forwarding. For one example, if the network node schedules DL transmission using the ID (e.g., C-RNTI) of the relay node, it would be one of legacy DL transmission or DL transmission for L2 relay (which one it is should be checked by the relay node after the relay node decodes the DL packet and check the packet content). In contrast, if the network node schedules DL transmission using the ID of the UE, it is RF or L1 relay. Which one of RF or L1 relay it is may depend on which relay mode the relay node supports, the indicated mode configured by the network, and/or the explicit signaling/indication in DCI.

In accordance with another novel aspect, for a relay node capable of multiple relay modes (RF/L1/L2 relay), for uplink (UL) traffic, a relay node can determine the relay mode based on the used resource for UE-to-UE communication or explicit message provided by the UE. For one example, if the relay node receives a packet from the UE on the dedicated resource for UE-to-UE communication (e.g., not belonging to legacy UL resource), the relay node knows that the UE wants to apply L2 relay. If the UE transmits using legacy UL resource, the relay node knows that the UE applies the RF or L1 relay. For one example, if the UE indicates UL resource to the relay node for UL traffic forwarding, the relay node knows that the UE applies RF/L1 relay; otherwise, if the UE does not provide UL resource for UL traffic forwarding, it implicitly means the UE applies L2 relay. For one example, some UL resource may be configured dedicated for UE-to-UE communication. In this case, a UE may indicate in the control signaling associated with the data during UE-to-UE communication to indicate the transmission target (the relay node or the network node) and the relay mode (RF/L1/L2 relay) if the transmission target is the network node.

In accordance with another novel aspect, for a relay node capable of multiple relay modes (RF/L1/L2 relay), when the UE apply RF/L1 relay for uplink (UL) traffic, UL data is transmitted in UL resource, while control signaling associated with the UL data is transmitted on dedicated UE-to-UE communication resource, wherein the control signaling may indicate the relay mode. If the control signaling indicates RF/L1 relay, relay node would expect data reception in UL resource; in contrast, if the control signaling indicates L2 relay, relay node would expect data reception in dedicated UE-to-UE communication resource.

FIG. 3 is a simplified block diagram of a network node and a user equipment (UE) that carry out certain embodiments of the present invention. The network node 301 may be a base station (BS) or a gNB, but the present invention should not be limited thereto. The UE 302 may be a smart phone, a wearable device, an Internet of Things (IOT) device, and a tablet, etc. Alternatively, UE 302 may be a Notebook (NB) or Personal Computer (PC) inserted or installed with a data card which includes a modem and RF transceiver(s) to provide the functionality of wireless communication.

Network node 301 has an antenna array 311 having multiple antenna elements that transmits and receives radio signals, one or more RF transceiver modules 312, coupled with the antenna array 311, receives RF signals from antenna array 311, converts them to baseband signal, and sends them to processor 313. RF transceiver 312 also converts received baseband signals from processor 313, converts them to RF signals, and sends out to antenna array 311. Processor 313 processes the received baseband signals and invokes different functional modules 320 to perform features in network node 301. Memory 314 stores program instructions and data 315 to control the operations of network node 301. Network node 301 also includes multiple function modules that carry out different tasks in accordance with embodiments of the current invention.

Similarly, UE 302 has an antenna array 331, which transmits and receives radio signals. A RF transceiver 332, coupled with the antenna, receives RF signals from antenna array 331, converts them to baseband signals and sends them to processor 333. RF transceiver 332 also converts received baseband signals from processor 333, converts them to RF signals, and sends out to antenna array 331. Processor 333 processes the received baseband signals and invokes different functional modules 340 to perform features in UE 302. Memory 334 stores program instructions and data 335 to control the operations of UE 302. UE 302 also includes multiple function modules and circuits that carry out different tasks in accordance with embodiments of the current invention.

The functional modules and circuits 320 and 340 can be implemented and configured by hardware, firmware, software, and any combination thereof. The function modules and circuits 320 and 340, when executed by the processors 313 and 333 (e.g., via executing program codes 315 and 335), allow network node 301 and UE 302 to perform embodiments of the present invention.

In the example of FIG. 3, the network node 301 may comprise a configuration circuit 321 and a scheduling circuit 322. Configuration circuit 321 may generate a scheduling which indicates the relay node configurations associated with an aggregated group based on the capability information from the UE 302. The scheduling may comprise different configurations for the relay nodes in the aggregated group. Scheduling circuit 322 may transmit or schedule the scheduling for controlling the aggregated group to the UE 302.

In the example of FIG. 3, the UE 302 may comprise a detecting circuit 341, a reporting circuit 342 and a determining circuit 343. Detecting circuit 341 may detect the relay node(s). Reporting circuit 342 may transmit the capability information (or capability report) associated with the detected relay node(s) (i.e., the relay node(s) in the aggregated group) to the network node 301. Determining circuit 343 may determine at least one path from paths between the network node 301 and an aggregated group formed by the UE 302 and at least one relay node.

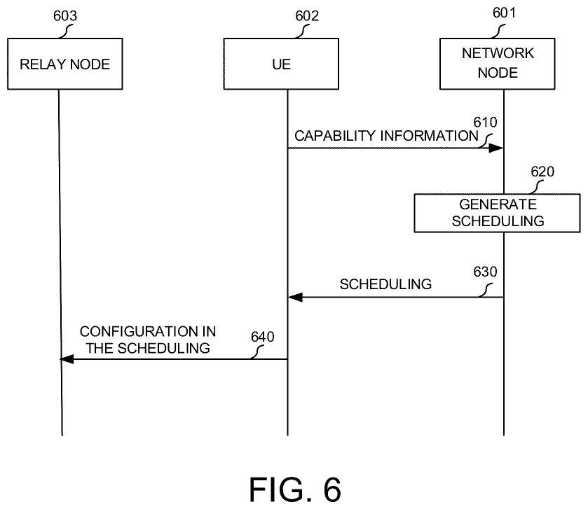

FIG. 6 illustrates a relay node configuration process in accordance with one novel aspect. In step 610, the UE 602 may transmit the capability information of an aggregated group formed by the UE 602 and the relay node 603 to the network node 601.

In step 620, after the network node 601 may generate a scheduling based on the capability information from the UE 602. If the aggregated group comprises more than one relay node 603, the scheduling may comprise different configurations for the relay nodes 603 in the aggregated group.

In step 630, the network 601 may transmit the scheduling for controlling the aggregated group to the UE 602.

In step 640, the UE 602 may transmit the configuration for the relay node 603 in the scheduling to the relay node 603.

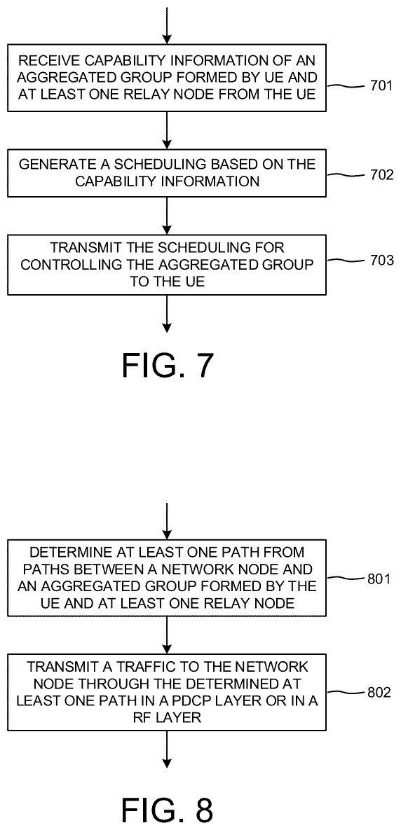

FIG. 7 is a flow chart of a method for configuring relay node configuration in accordance with one novel aspect. In step 701, a network node receives capability information of an aggregated group formed by a user equipment (UE) and at least one relay node from the UE.

In step 702, the network node generates a scheduling based on the capability information.

In step 703, the network node transmits the scheduling for controlling the aggregated group to the UE. The scheduling comprises different configurations for the at least one relay node in the aggregated group.

FIG. 8 is a flow chart of a method for applying protocol stack in accordance with one novel aspect. In step 801, a user equipment (UE) determines at least one path from paths between a network node and an aggregated group formed by the UE and at least one relay node.

In step 802, the UE transmits a traffic to the network node through the determined at least one path in a Packet Data Convergence Protocol (PDCP) layer or in a Radio Frequency (RF) layer.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method, comprising:
receiving, by a network node, capability information of an aggregated group formed by a user equipment (UE) and at least one relay node from the UE;
generating, by the network node, a scheduling based on the capability information;
transmitting, by the network node, the scheduling for controlling the aggregated group to the UE, wherein the scheduling comprises different configurations for the at least one relay node in the aggregated group.

2. The method of claim 1, wherein the scheduling comprises at least one of downlink control information (DCI), a medium-access-control control element (MAC CE) and a radio resource control (RRC) message.

3. The method of claim 1, wherein the configuration comprises at least one of a power configuration, a frequency resource configuration, a measurement configuration, an uplink (UL) grant, a downlink (DL) assignment and a physical uplink control channel (PUCCH) resource.

4. A network node, comprising:
a receiver, receiving capability information of an aggregated group formed by a user equipment (UE) and at least one relay node from the UE;
a processor, generating a scheduling based on the capability information; and
a transmitter, transmitting the scheduling for controlling the aggregated group to the UE, wherein the scheduling comprises different configurations for the at least one relay node in the aggregated group.

5. The network node of claim 4, wherein the scheduling comprises at least one of downlink control information (DCI), a medium-access-control control element (MAC CE) and a radio resource control (RRC) message.

6. The network node of claim 4, wherein the configuration comprises at least one of a power configuration, a frequency resource configuration, a measurement configuration, an uplink (UL) grant, a downlink (DL) assignment and a physical uplink control channel (PUCCH) resource.

7. A method, further comprising:
determining, by a user equipment (UE), at least one path from paths between a network node and an aggregated group formed by the UE and at least one relay node; and
transmitting, by the UE, a traffic to the network node through the determined at least one path in a Packet Data Convergence Protocol (PDCP) layer or in a Radio Frequency (RF) layer.

8. The method of claim 7, wherein the transmitting the traffic to the network node through the determined at least one path in the PDCP layer further comprises:
transmitting, by the UE, the traffic to at least one layer 2 (L2) relay node of the aggregated group through a PC5 interface.

9. The method of claim 7, wherein the transmitting the traffic to the network node through the determined at least one path in the PDCP layer further comprises:
transmitting, by the UE, the traffic to the network node directly through an Uu interface in an adaption layer.

10. The method of claim 7, wherein the transmitting the traffic to the network node through the determined at least one path in the PDCP layer further comprises:
transmitting, by the UE, the traffic to the network node directly through an Uu interface in a Radio Link Control (RLC) layer.

11. The method of claim 7, wherein the transmitting the traffic to the network node through the determined at least one path in the RF layer further comprises:
transmitting, by the UE, the traffic to at least one layer 1 (L1) relay node of the aggregated group through an Uu interface.

12. The method of claim 7, wherein the transmitting the traffic to the network node through the determined at least one path in the RF layer further comprises:
transmitting, by the UE, the traffic to the network node directly through an Uu interface.

13. The method of claim 7, wherein the transmitting the traffic to the network node through the determined at least one path in the RF layer further comprises:
transmitting, by the UE, the traffic to the network node through the determined at least one path in a Physical (PHY) layer.

14. A user equipment (UE), comprising:
a processor, determining at least one path from paths between a network node and an aggregated group formed by the UE and at least one relay node;
a transmitter, and transmitting a traffic to the network node through the determined at least one path in a Packet Data Convergence Protocol (PDCP) layer or in a Radio Frequency (RF) layer.

15. The UE of claim 14, wherein in an event that the transmitter transmits the traffic to the network node through the determined at least one path in the PDCP layer, the transmitter further transmits the traffic to at least one layer 2 (L2) relay node of the aggregated group through a PC5 interface.

16. The UE of claim 14, wherein in an event that the transmitter transmits the traffic to the network node through the determined at least one path in the PDCP layer, the transmitter further transmits the traffic to the network node directly through an Uu interface in an adaption layer.

17. The UE of claim 14, wherein in an event that the transmitter transmits the traffic to the network node through the determined at least one path in the PDCP layer, the transmitter further transmits the traffic to the network node directly through an Uu interface in a Radio Link Control (RLC) layer.

18. The UE of claim 14, wherein in an event that the transmitter transmits the traffic to the network node through the determined at least one path in the RF layer, the transmitter further transmits the traffic to at least one layer 1 (L1) relay node of the aggregated group through an Uu interface.

19. The UE of claim 14, wherein in an event that the transmitter transits the traffic to the network node through the determined at least one path in the RF layer, the transmitter further transmits the traffic to the network node directly through an Uu interface.

20. The UE of claim 14, wherein in an event that the transmitter transmits the traffic to the network node through the determined at least one path in the RF layer, the transmitter further transmits the traffic to the network node through the determined at least one path in a Physical (PHY) layer.
